(19) United States
(12) Patent Application Publication
(10) Pub. No.: US 2003/0103803 A1
(43) Pub. Date: Jun. 5, 2003

(54) Tool handle extension connector

(76) Inventor: Jan Axelsson, Bankeryd (SE)

Correspondence Address: Richard J Streit, Ladas & Parry, Suite 1200, 224 South Michigan Avenue, Chicago, IL, 60604, US

(21) Appl. No.: 10/169,881

(22) PCT Filed: Jan. 9, 2001
(86) PCT No.: PCT/SE01/00024

(51) Int. Cl. B25G 3/18; A45F 5/10

(52) U.S. Cl. 403/292; 403/329; 16/426; 403/300; 16/427

(57) ABSTRACT

The invention relates to a connector for connecting an extension handle with a painting tool. The connector comprises a locking means in the form of at least one shoulder (1) on the connector engaging a hole in the tool handle. The shoulder (1) is connected to a knob (2) via a tongue (3) which is integral with the connector and the knob (2) is placed such that it is located outside the tool handle. The front part of the connector may be split into two halves by a slit (4). The connector holds the tool firmly during the painting work. Also, it is easy to disconnect the tool from the connector. The tool may be e.g. a painter's roll or brush.

### FIELD OF USE OF THE PRODUCT

It is often desired to use an extension handle of painting tools in order to paint the ceiling and the floor and other places hard to reach more comfortably. The extension handle is connected to the tool by means of a connector, which is to hold the tool firmly during the painting work. Also, it should be easy to disconnect the tool from the connector. The tool may be e.g. a painter's roll or brush.

### STATE OF THE ART

Connectors for extension handles are previously known as such. Often they have shoulders engaging holes of the tool handle. When the tool is to be disconnected from the connector one has to press on the shoulder and depress it into the hole so that the tool may be pulled off. This may be difficult to perform as the holes are relatively small and one often works with gloves on the hands. The edge around the hole interferes with the inward movement of the fingers.

In the present invention the shoulder is located on a tongue together with a knob located outside the tool. The tool is disconnected from the connector by pressing on the knob. There is no hole edge round the knob and the knob may be suitably designed so that it is easy to depress.

### THE DRAWINGS

FIG. 1 shows the product according to the invention as viewed obliquely from behind, i.e. the attachment towards the extension handle.

FIG. 2 shows the connector obliquely from the front where the connector is to be attached to the tool.

FIG. 3 shows a split embodiment of the connector in a side view.

FIG. 4 shows the split connector as viewed from the other side with the split visible.

### DETAILED DESCRIPTION

In the figures there is shown the product according to the invention being used to connect a painting tool in the front end and an extension handle in the rear end. The tool and the handle are not shown. The connector is manufactured from a suitable plastic material being sufficiently rigid but also resilient in certain parts.

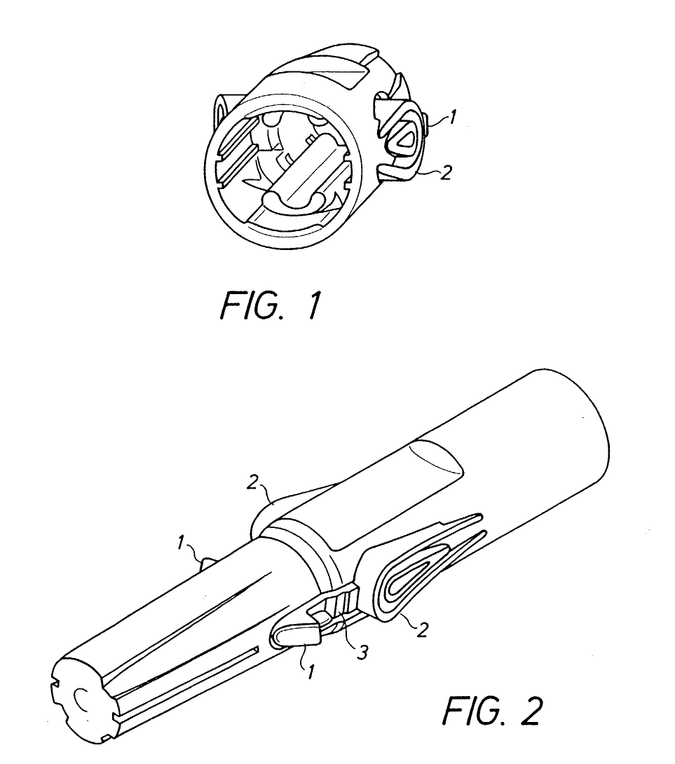

In FIG. 1 the rear part of the connector is shown in which an extension handle is to be inserted and held. The inside of the connector is provided with tongues and guide grooves, which do not form part of the invention as such.

In FIG. 2 the connector is shown from the front. A painting tool with a hollow handle is pushed on and guided by guide ribs. When the tool reaches a pair of shoulders 1, these are depressed under the edge of the tool handle and caught in recesses or holes in the handle.

The shoulders 1 have a ramp on one side and a face normal to the connector at the other side. Thus, to disconnect the tool the shoulders 1 have to be depressed. This is done by means of a knob 2, which is connected to the shoulder via a resilient tongue 3. The tongue merges with the connector at the edge behind the knob 2. The whole connector with the knobs and shoulders is formed in one piece.

Since the knob is not limited by any hole edge, it may be designed in an ergonomic way. As may be seen in the figure, the knob 2 has a ramp-shaped and drop-shaped design. It is the highest and widest in the front edge and tapers both in width and thickness at the rear edge where the knob merges with the connector.

For best function, the connector is suitably provided with a pair of shoulders 1 and knobs 2 arranged opposite each other at both sides of the connector. Thus, a more steady holding of the tool is achieved and the knobs 2 may be pressed against each other by pressing on them simultaneously.

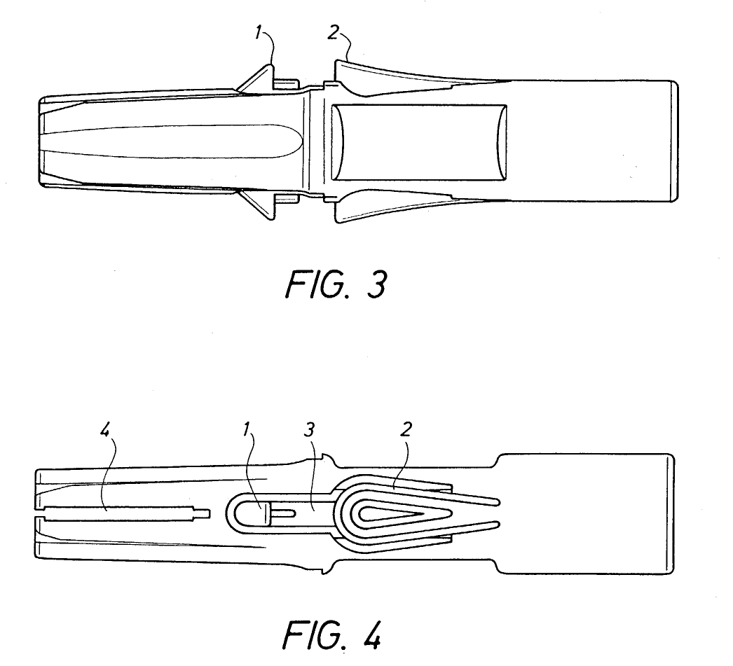

A further embodiment of the invention is shown in FIGS. 3 and 4. Just as in the first embodiment, the product is provided with shoulders 1, and knobs 2 connected by a tongue 3. In addition the front part is split in two halves by a slit 4 extending from the front almost all the way to the cutaway for the shoulder 1. The width of the slit may e.g. be approximately 15% of the diameter of the connector. The slit 4 enables the two halves to be pressed against each other since the product is made of an elastic material. The slit also makes the connector more easy to connect to the tool and also more tolerant to deviations in dimensions, both in the connector itself and the tool.

1. A connector for connecting an extension handle with a painting tool comprising a locking means in the form of at least one shoulder on the connector engaging a hole in the tool handle, characterised in that the shoulder (1) is connected to a knob (2) via a tongue (3) integral with the connector and in that the knob (2) is located outside the tool handle.

2. A connector according to claim 1, characterised in that the knobs (2) are configured as ramps, the widest and the highest at the front edge and tapering toward the end where the tongue (3) merges with the body of the connector.

3. A connector according to claim 1 or 2, characterised in that the connector comprises two shoulders (1) arranged in pairs with associated knobs (2).

4. A connector according to claim 3, characterised in that the knobs (2) are arranged opposite each other.

5. A connector according to anyone of claims 1-4, characterised in that the front part of the connector is split into two halves by a slit (4) extending from the front part almost all the way to the cutaway of the shoulder (1).

6. A connector according to claim 5, characterised in that the width of the slit (4) is approximately 15% of the diameter of the connector.
